(19) United States
(12) Patent Application Publication
(10) Pub. No.: US 2024/0276274 A1
(43) Pub. Date: Aug. 15, 2024

(54) METHOD FOR DETERMINING PRIORITY OF CSI REPORT AND RELATED DEVICES

(71) Applicant: BEIJING UNISOC COMMUNICATIONS TECHNOLOGY CO., LTD., Beijing (CN)

(72) Inventor: Hualei WANG, Beijing (CN)

(73) Assignee: BEIJING UNISOC COMMUNICATIONS TECHNOLOGY CO., LTD., Beijing (CN)

(21) Appl. No.: 18/569,363

(22) PCT Filed: Jun. 14, 2022
(86) PCT No.: PCT/CN2022/098663

§ 371 Date: Dec. 12, 2023

(30) Foreign Application Priority Data
Jun. 29, 2021 (CN) 202110740338.0

(51) Int. Cl. H04W 24/10

(52) U.S. Cl. CPC H04W 24/10

(57) ABSTRACT

A method and apparatus for determining a priority of a channel state information (CSI) report and related devices are provided. The method includes the following. A network device sends configuration information. A terminal obtains the configuration information. The terminal determines, according to the configuration information, a priority of a CSI report at least carrying Doppler information. Since the configuration information is used for determining the priority of the CSI report at least carrying the Doppler information, it is possible to determine the priority of the CSI report at least carrying the Doppler information according to the configuration information, thereby ensuring robustness and stability of system communication.

### CROSS-REFERENCE TO RELATED APPLICATION(S)

This application is a National Stage of International Application No. PCT/CN2022/098663, field Jun. 14, 2022, which claims priority to Chinese Patent Application No. 202110740338.0, filed Jun. 29, 2021, the entire disclosures of which are hereby incorporated by reference.

### TECHNICAL FIELD

This disclosure relates to the field of communication technology, and more particularly, to a method for determining a priority of a channel state information (CSI) report and related devices.

### BACKGROUND

Relevant studies on a priority rule for a channel state information (CSI) report have been conducted in a standard protocol formulated by the 3rd generation partnership project (3GPP).

However, with continuous evolution of the standard protocol formulated by 3GPP, a CSI report is likely to carry (or contain/carry) new information, and therefore, how to specify a priority rule for a CSI report carrying (or containing/carrying) new information needs to be further studied.

### SUMMARY

In a first aspect, a method for determining a priority of a CSI report is provided in embodiments of the disclosure. The method includes the following. A terminal obtains configuration information. The terminal determines, according to the configuration information, a priority of a CSI report at least carrying Doppler information.

In a second aspect, a terminal is provided in embodiments of the disclosure. The terminal includes a processor, a memory, a communication interface, and at least one program. The at least one program is stored in the memory and configured to be executed by the processor, and the at least one program includes instructions for implementing steps in the first aspect of the disclosure.

In a third aspect, a non-transitory computer-readable storage medium is provided in embodiments of the disclosure. The computer-readable storage medium is configured to store computer programs and data for electronic data interchange (EDI). The computer programs and data are operable with a computer to implement some or all of the steps described in the first aspect of the disclosure.

### BRIEF DESCRIPTION OF THE DRAWINGS

In order to describe more clearly technical solutions of embodiments of the disclosure, the following will give a brief introduction to the accompanying drawings used for describing embodiments or the related art. Apparently, the accompanying drawings described below are merely some embodiments of the disclosure. Based on these drawings, those of ordinary skill in the art can also obtain other drawings without creative effort.

FIG. 1 is a schematic architectural diagram of a wireless communication system provided in embodiments of the disclosure.

FIG. 2 is a schematic flowchart of a method for determining a priority of a channel state information (CSI) report provided in embodiments of the disclosure.

FIG. 3 is a block diagram illustrating functional units of an apparatus for determining a priority of a CSI report provided in embodiments of the disclosure.

FIG. 4 is a block diagram illustrating functional units of another apparatus for determining a priority of a CSI report provided in embodiments of the disclosure.

FIG. 5 is a schematic structural diagram of a terminal provided in embodiments of the disclosure.

FIG. 6 is a schematic structural diagram of a network device provided in embodiments of the disclosure.

### DETAILED DESCRIPTION

In order for those skilled in the art to better understand the technical solutions of the disclosure, the following will describe in detail the technical solutions of embodiments of the disclosure with reference to the accompanying drawings in the embodiments of the disclosure. Apparently, embodiments described herein are merely some embodiments, rather than all embodiments, of the disclosure. Based on the embodiments of the disclosure, all other embodiments obtained by those of ordinary skill in the art without creative effort shall fall within the protection scope of the disclosure.

The terms “first”, “second”, etc. in the specification and claims of the disclosure and in the accompanying drawings are intended for distinguishing different objects rather than describing a particular order. In addition, the terms “include”, “comprise”, and “have” as well as variations thereof are intended to cover non-exclusive inclusion. For example, a process, method, software, product, or device including a series of steps or units is not limited to the listed steps or units, instead, it may optionally include other steps or units that are not listed, or may optionally include other steps or units inherent to the process, method, product, or device.

The term “embodiment” referred to herein means that a particular feature, structure, or characteristic described in conjunction with the embodiment may be contained in at least one embodiment of the disclosure. The phrase appearing in various places in the specification does not necessarily refer to the same embodiment, nor does it refer to an independent or alternative embodiment that is mutually exclusive with other embodiments. It is explicitly and implicitly understood by those skilled in the art that an embodiment described herein may be combined with other embodiments.

It should be noted that, the term “connection” in embodiments of the disclosure refers to various connection modes such as direct connection or indirect connection, so as to implement communication between devices, which is not limited herein. The terms “network” and “system” in embodiments of the disclosure refer to the same concept, and a communication system refers to a communication network.

The technical solutions of embodiments of the disclosure can be applied to various wireless communication systems, for example, a global system of mobile communication (GSM), a code division multiple access (CDMA) system, a wideband code division multiple access (WCDMA) system, a general packet radio service (GPRS), a long term evolution (LTE) system, an advanced LTE (LTE-A) system, a new radio (NR) system, an evolved system of an NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area network (WLAN), a wireless fidelity (WiFi), a 6th-generation (6G) communication system, or other communication systems, etc.

It should be noted that, a conventional wireless communication system supports a limited quantity of connections and therefore is easy to implement. However, with development of communication technology, a wireless communication system will not only support a conventional wireless communication system but also support, for example, device to device (D2D) communication, machine to machine (M2M) communication, machine type communication (MTC), vehicle to vehicle (V2V) communication, vehicle to everything (V2X) communication, narrow band internet of things (NB-IoT) communication, etc. Therefore, technical solutions of embodiments of the disclosure can also be applied to these wireless communication systems.

Optionally, the wireless communication system in embodiments of the disclosure can be applied to a beamforming scenario, a carrier aggregation (CA) scenario, a dual connectivity (DC) scenario, or a standalone (SA) deployment scenario, etc.

Optionally, the wireless communication system in embodiments of the disclosure can be applied to an unlicensed spectrum, where the unlicensed spectrum may be considered as a shared spectrum. Alternatively, the wireless communication system in embodiments may be applied to a licensed spectrum, where the licensed spectrum may be considered as a non-shared spectrum.

Since various embodiments may be described in conjunction with a terminal and a network device in embodiments of the disclosure, a terminal, a relay device, and a network device involved will be described in detail below.

Specifically, the terminal may be a user equipment (UE), a remote terminal (remote UE), a relay device (relay UE), an access terminal, a subscriber unit, a subscriber station, a mobile station, a remote station, a mobile device, a user terminal, a smart terminal, a wireless communication device, a user agent, or a user device. It should be noted that, the relay device is a terminal capable of providing relay forwarding services for other terminals (including a remote terminal). In addition, the terminal may also be a cellular radio telephone, a cordless telephone, a session initiation protocol (SIP) telephone, a wireless local loop (WLL) station, a personal digital assistant (PDA), a handheld device or a computing device with wireless communication functions, other processing devices coupled with a wireless modem, an in-vehicle device, a wearable device, and a terminal in a next-generation communication system (for example, an NR communication system, a 6G communication system), or a terminal in a future evolved public land mobile network (PLMN), etc., which is not limited herein.

In addition, the terminal may be deployed on land, which includes indoor or outdoor, handheld, wearable, or in-vehicle. The terminal may also be deployed on water (such as ships, etc.). The terminal may also be deployed in the air (such as airplanes, balloons, satellites, etc.).

In addition, the terminal may be a mobile phone, a pad, a computer with wireless transceiver functions, a virtual reality (VR) terminal device, an augmented reality (AR) terminal device, a wireless terminal device in industrial control, a wireless terminal device in self driving, a wireless terminal device in remote medicine, a wireless terminal device in smart grid, a wireless terminal device in transportation safety, a wireless terminal device in smart city, or a wireless terminal device in smart home, etc.

Specifically, the network device may be a device for communicating with the terminal, and is responsible for radio resource management (RRM), quality of service (QoS) management, data compression and encryption, data transmission and reception, etc. at an air-interface side. The network device may be a base station (BS) in a communication system or a device deployed on a radio access network (RAN) and used for providing wireless communication functions, for example, a base transceiver station (BTS) in a GSM or CDMA communication system, a node B (NB) in a WCDMA communication system, and an evolutional node B (eNB or eNodeB) in an LTE communication system, a next-generation evolved node B (ng-eNB) in an NR communication system, and a next-generation node B (gNB) in an NR communication system. In addition, the network device may be other devices in a core network (CN), such as an access and mobility management function (AMF), a user plane function (UPF), etc., or may be an access point (AP) in a WLAN, a relay station, a communication device in a future evolved PLMN network, a communication device in an NTN network, etc.

It should be noted that, in some network deployments, the network device may be an independent node so as to implement all functions of the base station, and may include a centralized unit (CU) and a distributed unit (DU), such as a gNB-CU and a gNB-DU. The network device may further include an active antenna unit (AAU). The CU can implement some functions of the network device, and the DU can implement some other functions of the network device. For example, the CU is responsible for processing non-real-time protocols and services, and implements functions of a radio resource control (RRC) layer, functions of a service data adaptation protocol (SDAP) layer, and functions of a packet data convergence protocol (PDCP) layer. The DU is responsible for processing physical (PHY) layer protocols and real-time services, and implements functions of a radio link control (RLC) layer, functions of a media access control (MAC) layer, and functions of a PHY layer. In addition, the AAU can implement some PHY layer processing functions, radio frequency processing functions, and active-antenna related functions. Since RRC layer information will eventually become PHY layer information, or will be transformed from PHY layer information, in such network deployment, it may be considered that higher layer signaling, such as RRC layer signaling, is transmitted by the DU, or transmitted by the DU and the AAU. It can be understood that, the network device may include at least one of the CU, the DU, or the AAU. In addition, the CU may be categorized into a network device in a RAN, or may be categorized into a network device in a CN, which is not limited herein.

In addition, the network device may be mobile. For example, the network device may be a mobile device. Optionally, the network device may be a satellite or a balloon base station. For example, the satellite may be a low earth orbit (LEO) satellite, a medium earth orbit (MEO) satellite, a geostationary earth orbit (GEO) satellite, a high elliptical orbit (HEO) satellite, etc. Optionally, the network device may also be a base station deployed on land or water.

In addition, the network device can serve a cell, and a terminal(s) in the cell can communicate with the network device over a transmission resource (for example, a spectrum resource). The cell may include a macro cell, a small cell, a metro cell, a micro cell, a pico cell, a femto cell, and the like.

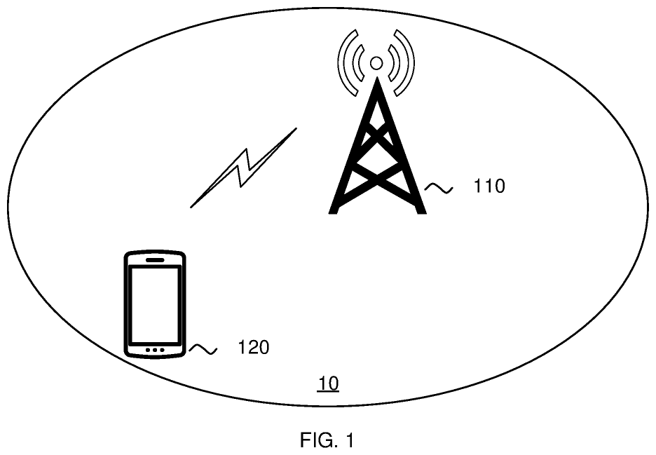

Exemplarily, referring to FIG. 1, FIG. 1 illustrates a wireless communication system according to embodiments of the disclosure. The wireless communication system 10 may include a network device 110 and a terminal 120. The network device 110 may be a device for communicating with the terminal 120. In addition, the network device 110 may provide communication coverage for a specific geographical area, and may communicate with the terminal(s) 120 within the coverage area.

Optionally, the wireless communication system 10 may include multiple network devices, and there may be certain quantities of terminals in a coverage area of each of the network devices, which is not limited herein.

Optionally, the wireless communication system 10 may further include other network entities such as a network controller and a mobility management entity, which is not limited herein.

Optionally, communication between the network device and the terminal and communication between the terminals in the wireless communication system 10 may be wireless communication or wired communication, which is not specifically limited herein.

Related contents involved in technical solutions of embodiments of the disclosure will be introduced below.

### 1. Channel State Information (CSI)

Relevant studies on CSI have been conducted in a protocol standard formulated by the 3rd generation partnership project (3GPP). The CSI is used for the terminal to feedback downlink channel quality to the network device, so that the network device selects a suitable modulation and coding scheme (MCS) for downlink data transmission, thereby reducing a block error rate (BLER) of downlink data transmission, and implementing corresponding operations such as beam management, mobility management, adaptive tracking, and rate matching.

CSI may consist of at least one of: layer 1 reference signal received power (L1-RSRP)-related information, L1 signal-to-noise and interference ratio (L1-SINR)-related information, or CSI-related information, etc. The CSI-related information may consist of at least one of: a channel quality indicator (CQI), a precoding matrix indicator (PMI), a CSI-reference signal resource indicator (CSI-RS resource indicator, CRI), a synchronization signal/physical broadcast channel block resource indicator (SS/PBCH block resource indicator, SSBRI), a layer indicator (LI), or a rank indicator (RI), etc.

Related configuration information for CSI may be defined by a higher-layer parameter CSI-MeasConfig, where CSI-MeasConfig defines a higher-layer parameter CSI-ResourceConfig and a higher-layer parameter CSI-ReportConfig, etc. The higher-layer parameter CSI-ResourceConfig may be used to configure a CSI-RS resource used for CSI measurement. The higher-layer parameter CSI-ReportConfig may be used to configure how to report CSI (namely, configuration information for a CSI report).

A resource set (for example, ResourceSet) may be configured by the higher-layer parameter CSI-ResourceConfig. ResourceSet may define the most common CSI-RS resource (for example, CSI-RS-Resource). CSI-RS-Resource may define three types of resource sets, namely a non-zero-power (NZP)-CSI-RS resource set (NZP-CSI-RS-ResourceSet), a CSI interference management (CSI-IM) resource set (CSI-IM-ResourceSet), a CSI-SSB resource set (CSI-SSB-ResourceSet). The type of the CSI-RS resource may be periodic, semi-persistent, or aperiodic.

reportConfigType in the higher-layer parameter CSI-ReportConfig may be used to indicate a report type of a CSI report. The CSI report may be reported on a physical uplink control channel (PUCCH) or a physical uplink shared channel (PUSCH).

### 2. CSI Report

A report type of a CSI report may include a periodic CSI report (namely, periodic CSI reporting on a PUCCH), an aperiodic CSI report (namely, aperiodic CSI reporting on a PUSCH), a semi-persistent CSI report carried on a PUCCH, and a semi-persistent CSI report carried on a PUSCH.

For an aperiodic CSI report and a semi-persistent CSI report carried on a PUSCH, a network side may further configure a higher-layer parameter TriggerState and a higher-layer parameter reportTriggerSize that apply to a CSI request field in downlink control information (DCI).

Periodic CSI report: it will take effect immediately after a periodic CSI-RS resource and report parameter are configured by radio resource control (RRC), without activating or triggering CSI-RS transmission and CSI report by a media access control-control element (MAC-CE)/DCI.

Semi-persistent CSI report carried on a PUCCH: if semi-persistent CSI-RS transmission is configured by RRC, it is necessary to firstly activate the CSI-RS transmission by MAC CE 1, and then activate CSI report by MAC CE 2. If periodic CSI-RS transmission is configured by RRC, it is only necessary to activate CSI report by MAC CE 2, and there is no need to activate the CSI-RS transmission by MAC CE 1.

Semi-persistent CSI report carried on a PUSCH: if semi-persistent CSI-RS transmission is configured by RRC, it is necessary to firstly activate the CSI-RS transmission by MAC CE 1 and then trigger CSI report by DCI. If periodic CSI-RS transmission is configured by RRC, it is only necessary to trigger CSI report by DCI, and there is no need to activate the CSI-RS transmission by MAC CE 1. It should be noted that, for the DCI, the DCI may be DCI format 0-1 scrambled by a semi-persistent CSI radio network temporary identifier (SP-CSI-RNTI), and a CSI request field in the DCI may be associated with a corresponding trigger state (TriggerState) by setting a codepoint. TriggerState may define associated CSI-ReportConfig, so that a parameter CSI-ReportConfig (namely, configuration information for a CSI report) associated with a semi-persistent CSI report on a PUSCH can be found according to TriggerState.

Aperiodic CSI report: for a scenario of aperiodic CSI-RS transmission and aperiodic CSI report, both aperiodic CSI-RS transmission and aperiodic CSI report are triggered by DCI, and the procedure thereof is similar to that for the semi-persistent CSI report described above. When associating corresponding TriggerState with a codepoint of a CSI request field in DCI format 0_1/0_2, different from DCI triggering of semi-persistent CSI report, if the value of the CSI request field is “000”, it indicates that there is no need to trigger aperiodic CSI report; and if the value of the CSI request field is “001”, it indicates that aperiodic CSI report associated with TriggerState 1 is to be triggered, and so forth. After TriggerState is associated, the terminal can obtain two important higher-layer parameters, namely CSI-ReportConfig and resourceSet, where NZP-CSI-RS-ResourceSet in the higher-layer parameter resourceSet is used for channel measurement.

### 3. Quasi Co-Location (QCL)

In order to ensure correct reception and demodulation of a signal, the concept of RSs, such as CSI-RSs, having a QCL relationship is introduced in a standard protocol, so that the terminal can estimate a large-scale/small-scale parameter according to a CSI-RS. The large-scale/small-scale parameter includes at least one of: a delay spread, a Doppler spread, a Doppler shift, an average gain, an average delay, or spatial information, etc. For example, antenna port QCL is introduced in a standard protocol for an LTE communication system release 11 (R11). Antenna port QCL may mean that signals transmitted from antenna ports may undergo the same large-scale fading and thus have the same large-scale/small-scale parameter. For example, if antenna port A and antenna port B are in a QCL relationship, a large-scale/small-scale parameter obtained by estimating a signal on antenna port A is also applicable to a signal on antenna port B.

In addition, in an NR communication system, the terminal and the network device may be configured with a large array of multiple antenna panels, and large-scale properties of beams formed by different antenna panels may also be different. In this case, in addition to the delay spread, the Doppler spread, the Doppler shift, the average gain, and the average delay described above, the large-scale parameter further includes an angle of arrival (AOA), an AOA spread, an angle of departure (AOD), an AOD spread, and a spatial correlation, etc.

To summarize, in the standard protocol formulated by 3GPP, the report type of the CSI report may include a periodic CSI report, an aperiodic CSI report, a semi-persistent CSI report carried on a PUCCH, and a semi-persistent CSI report carried on a PUSCH. The CSI report is likely to carry (or contain/carry) at least one of: L1-RSRP-related information, L1-SINR-related information, or CSI-related information, etc.

However, with continuous evolution of the standard protocol formulated by 3GPP, the CSI report may also carry (or contain/carry) new information besides the information described above, and therefore, how to specify a priority rule for a CSI report carrying new information needs to be further studied.

Embodiments of the disclosure provide a method and apparatus for determining a priority of a channel state information (CSI) report and related devices, so as to determine a priority of a CSI report at least carrying Doppler information according to configuration information, thereby ensuring robustness and stability of system communication.

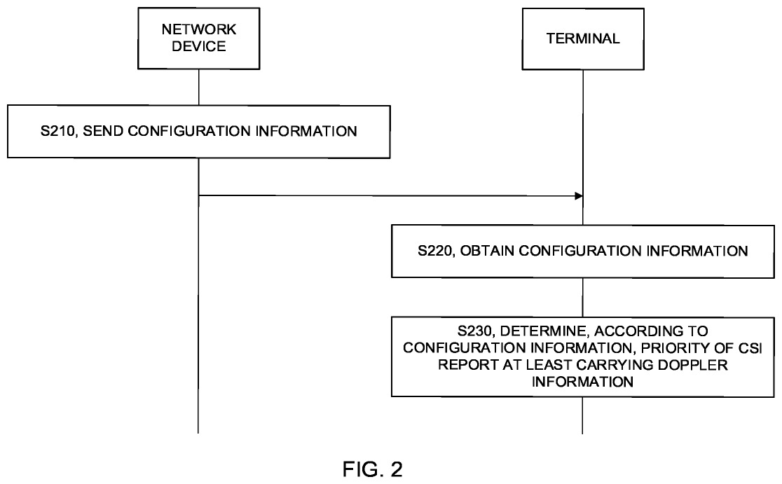

With reference to the elaboration above, embodiments of the disclosure provide a method for determining a priority of a CSI report. As illustrated in FIG. 2, the method includes the following.

S210, a network device sends configuration information.

The configuration information may be used for determining a priority of a CSI report at least carrying Doppler information.

S220, a terminal obtains the configuration information.

S230, the terminal determines, according to the configuration information, the priority of the CSI report at least carrying the Doppler information.

As can be seen, the network device sends the configuration information. The terminal obtains the configuration information, and determines the priority of the CSI report at least carrying the Doppler information according to the configuration information. Since the configuration information is used for determining the priority of the CSI report at least carrying the Doppler information, it is possible to determine the priority of the CSI report at least carrying the Doppler information according to the configuration information, thereby ensuring robustness and stability of system communication.

It should be noted that, studies related to CSI have been conducted in a protocol standard formulated by 3GPP. The CSI is CSI used for the terminal to feed back downlink channel quality to the network device, so that the network device selects a suitable MCS for downlink data transmission, thereby reducing a BLER of downlink data transmission, and implementing corresponding operations such as beam management, mobility management, adaptive tracking, and rate matching. After the terminal performs channel measurement and interference measurement, a CSI report reported by the terminal is likely to carry (or contain/carry) at least one of: L1-RSRP-related information, L1-SINR-related information, or CSI-related information, etc.

However, during signal transmission between a transmitter and a receiver that are in motion, frequency change will occur to a received signal of the receiver due to movement of the transmitter and/or the receiver, and thus Doppler effect occurs. In order to measure and evaluate large-scale/small-scale fading of a channel, ensure correct reception and demodulation of a signal, and improve robustness and stability of system communication, the case where a CSI report is to at least carry Doppler information is taken into consideration in the disclosure.

In addition, since each CSI report is associated with one priority value, if a priority value associated with a first CSI report is lower than a priority value associated with a second CSI report, a priority of the first CSI report is higher than a priority of the second CSI report. As such, according to priorities of CSI reports, it is possible to determine an order in which the terminal is to transmit multiple CSI reports, determine how the terminal is to transmit CSI reports, or determine which CSI report(s) the terminal needs to transmit, etc.

For example, if two CSI reports are transmitted on the same carrier and overlap in at least one orthogonal frequency-division multiplexing (OFDM) symbol in time domain, the two CSI reports will collide when transmitted. When the terminal is configured to transmit two colliding CSI reports, if the two CSI reports have different report types, the terminal transmits only the CSI report with a higher priority except for the case where one of the two CSI reports is a semi-persistent CSI report carried on a PUCCH and the other one of the two CSI reports is a periodic CSI report carried on a PUCCH; otherwise, the two CSI reports are multiplexed and transmitted based on priority, or the CSI report with a lower priority is dropped based on priority.

Based on this, in order to determine the priority of the CSI report at least carrying the Doppler information, in the disclosure, the network device sends the configuration information to the terminal, then the terminal determines, according to the configuration information, the priority of the CSI report at least carrying the Doppler information. In this way, the priority of the CSI report at least carrying the Doppler information can be determined according to the configuration information, thereby ensuring robustness and stability of system communication.

With the above illustration, the technical solutions involved in the above method will be elaborated below in embodiments of the disclosure.

Specifically, the Doppler information may include at least one of: at least one Doppler shift, at least one Doppler spread, at least one Doppler shift difference, or at least one Doppler spread difference.

It should be noted that, during signal transmission between the transmitter and the receiver that are in motion, Doppler effect may occur to the received signal of the receiver. Doppler effect may lead to frequency change (namely, Doppler shift) of the received signal, and Doppler effect may lead to frequency spread (namely, Doppler spread) of the received signal. Similarly, Doppler effect may also lead to Doppler shift difference and Doppler spread difference of the received signal. Therefore, the terminal in the disclosure reports the CSI report carrying the Doppler information, thereby facilitating channel measurement and evaluation, facilitating Doppler pre-compensation of the transmitter, and improving robustness and stability of system communication.

Specifically, the Doppler information may be determined according to at least one of: a CSI-RS, a tracking reference signal (TRS), a demodulation reference signal (DMRS), a data channel, or a control channel.

It should be noted that, in embodiments of the disclosure, the Doppler information can be obtained by measuring and evaluating at least one of a CSI-RS, a TRS, a DMRS, a data channel, or a control channel.

Specifically, the configuration information may include at least one of: a first configuration parameter, a second configuration parameter, a third configuration parameter, a fourth configuration parameter, a fifth configuration parameter, a sixth configuration parameter, or a seventh configuration parameter. A value of the first configuration parameter is determined according to a maximum number of serving cells. A value of the second configuration parameter is determined according to a maximum number of CSI report configurations. A value of the third configuration parameter is determined according to a report type of the CSI report. A value of the fourth configuration parameter is determined according to an information type to be carried in the CSI report. A value of the fifth configuration parameter is determined according to an index of a serving cell. A value of the sixth configuration parameter is determined according to a configuration identity (ID) for the CSI report. A value of the seventh configuration parameter is determined according to a value range of the fourth configuration parameter.

It should be noted that, the configuration information in the disclosure may be defined by a higher-layer parameter CSI-MeasConfig. The higher-layer parameter CSI-MeasConfig defines a higher-layer parameter CSI-ResourceConfig and a higher-layer parameter CSI-ReportConfig. The higher-layer parameter CSI-ResourceConfig may be used to configure a CSI-RS resource used for CSI measurement. The higher-layer parameter CSI-ReportConfig may be used to configure how to report CSI (namely, configuration information for a CSI report).

The higher-layer parameter CSI-ReportConfig is defined as follows:

| | |
|---|---|
| CSI-ReportConfig ::= | SEQUENCE { |

reportConfigId CSI-ReportConfigId,

| | |
|---|---|
| carrier ServCellIndex | OPTIONAL, |
| resourcesForChannelMeasurement | CSI-ResourceConfigId, |
| csi-IM-ResourcesForInterference | CSI-ResourceConfigId OPTIONAL, |
| nzp-CSI-RS-ResourcesForInterference | CSI-ResourceConfigId OPTIONAL, |
| reportConfigType | CHOICE { |
| periodic | SEQUENCE { |
| reportSlotConfig | CSI-ReportPeriodicityAndOffset, |
| pucch-CSI-ResourceList | SEQUENCE (SIZE (1..maxNrofBWPs)) OF PUCCH-CSI- |

Resource
},

| | |
|---|---|
| semiPersistentOnPUCCH | SEQUENCE { |
| reportSlotConfig | CSI-ReportPeriodicityAndOffset, |
| pucch-CSI-ResourceList | SEQUENCE (SIZE (1..maxNrofBWPs)) OF PUCCH-CSI- |

Resource
},

| | |
|---|---|
| semiPersistentOnPUSCH | SEQUENCE { |
| reportSlotConfig | ENUMERATED {sl5, sl10, sl20, sl40, sl80, sl160, sl320}, |
| reportSlotOffsetList | SEQUENCE (SIZE (1.. maxNrofUL-Allocations)) OF |

INTEGER(0..32),

| | |
|---|---|
| p0alpha | P0-PUSCH-AlphaSetId |

},

| | |
|---|---|
| aperiodic | SEQUENCE { |
| reportSlotOffsetList | SEQUENCE (SIZE (1..maxNrofUL-Allocations)) OF |

```
INTEGER(0..32)
    }
      },
```

| | |
|---|---|
| reportQuantity | CHOICE { |
| none | NULL, |
| cri-RI-PMI-CQI | NULL, |
| cri-RI-i1 | NULL, |
| cri-RI-i1-CQI | SEQUENCE { |
| pdsch-BundleSizeForCSI | ENUMERATED {n2, n4} OPTIONAL |

},

| | |
|---|---|
| cri-RI-CQI | NULL, |
| cri-RSRP | NULL, |
| ssb-Index-RSRP | NULL, |
| cri-RI-LI-PMI-CQI | NULL |

```
      },
  ...
  }
```

A higher-layer parameter carrier may indicate in which serving cell the indicated higher-layer parameter CSI-ResourceConfig is to be found. In addition, the higher-layer parameter carrier may indicate an index of a serving cell (indicated by a higher-layer parameter ServCellIndex), where the index indicates that a resource corresponding to the indicated higher-layer parameter CSI-ResourceConfig is to be found in a serving cell corresponding to the index.

A higher-layer parameter reportConfigId may be used to identify the higher-layer parameter CSI-ReportConfig.

A higher-layer parameter reportConfigType may indicate a report type of the CSI report.

A higher-layer parameter reportQuantity may indicate the information type to be carried in the CSI report.

The higher-layer parameter CSI-ReportConfig is defined as follows:

CSI-ReportConfigId::=INTEGER (0 . . . maxNrofCSI-ReportConfigurations-1)

Optionally, the value of the first configuration parameter (N_{cells}) may be a value of a higher-layer parameter maxNrofServingCells.

Optionally, the value of the second configuration parameter (Mₛ) may be a value of a higher-layer parameter maxNrofCSI-ReportConfigurations.

Optionally, the value of the third configuration parameter (y) may be determined according to the report type of the CSI report indicated by the higher-layer parameter reportConfigType.

The report type of the CSI report may include at least one of: an aperiodic CSI report to be carried on a PUSCH, a semi-persistent CSI report to be carried on a PUSCH, a semi-persistent CSI report to be carried on a PUCCH, or a periodic CSI report to be carried on a PUCCH.

For example, for an aperiodic CSI report scheduled to be carried on a PUSCH, the value of y may be 0. For a semi-persistent CSI report scheduled to be carried on a PUSCH, the value of y may be 1. For a semi-persistent CSI report scheduled to be carried on a PUCCH, the value of y may be 2. For a periodic CSI report scheduled to be carried on a PUCCH, the value of y may be 3.

Optionally, the value of the fourth configuration parameter (k) may be determined according to the information type to be carried in the CSI report indicated by the higher-layer parameter reportQuantity.

The information type to be carried in the CSI report may include at least one of: Doppler information, L1-RSRP-related information, L1-SINR-related information, or CSI-related information. The CSI-related information may include one of: a CQI, a PMI, a CRI, an SSBRI, an L1, or an RI.

For example, for a CSI report carrying (or containing/carrying) L1-RSRP-related information or L1-SINR-related information, the value of k may be 0. For a CSI report that does not carry (or not contain/carry) L1-RSRP related information or L1-SINR related information, the value of k may be 1. For a CSI report carrying (or containing/carrying) Doppler information, the value of k may be one of −1, 0, 0.5, 1, or 2.

Optionally, the value of the fifth configuration parameter (c) may be an index of a serving cell.

Optionally, the value of the sixth configuration parameter (s) may be a value of the higher-layer parameter reportConfigID.

Optionally, the value of the seventh configuration parameter (m) may be determined according to the value range of the fourth configuration parameter. For a CSI report carrying Doppler information, the value range of the fourth configuration parameter may be [−1, 2].

For example, for a CSI report carrying (or containing/carrying) Doppler information, the value of k may be 0 or 1, and the value of m may be 2. Alternatively, for a CSI report carrying (or containing/carrying) Doppler information, the value of k may be −1, 0.5, or 2, and the value of m may be 3.

As can be seen, in S230, the priority of the CSI report at least carrying the Doppler information may be determined according to the configuration information as follows. The terminal determines the priority of the CSI report at least carrying the Doppler information by using the configuration information according to a preset formula, where the preset formula satisfies:

$$\\ P = m \cdot {N}_{cells} \cdot {M}_{s} \cdot y + {N}_{cells} \cdot {M}_{s} \cdot k + {M}_{s} \cdot c + s$$

P represents a value of the priority of the CSI report, N_{cells} represents the first configuration parameter, Mₛ represents the second configuration parameter, y represents the third configuration parameter, k represents the fourth configuration parameter, c represents the fifth configuration parameter, s represents the sixth configuration parameter, and m represents the seventh configuration parameter.

In connection with the above elaboration, the value of the priority of the CSI report will be exemplified below.

### Example 1

A CSI report may be associated with one priority value, and the priority value is as follows:

$$\\ P = 2 \cdot {N}_{cells} \cdot {M}_{s} \cdot y + {N}_{cells} \cdot {M}_{s} \cdot k + {M}_{s} \cdot c + s$$

For an aperiodic CSI report scheduled to be carried on a PUSCH, y=0. For a semi-persistent CSI report scheduled to be carried on a PUSCH, y=1. For a semi-persistent CSI report scheduled to be carried on a PUCCH, y=2. For a periodic CSI report scheduled to be carried on a PUCCH, y=3.

For a CSI report carrying L1-RSRP-related information or L1-SINR-related information, k=0; for a CSI report not carrying L1-RSRP-related information or L1-SINR-related information, k=1; and/or for a CSI report carrying Doppler information, k=0; for a CSI report not carrying Doppler information but carrying L1-RSRP-related information or L1-SINR-related information, k=0; for a CSI report not carrying Doppler information but carrying CSI-related information, k=1.

The value of N_{cells} is the value of the higher-layer parameter maxNrofServingCells.

The value of Mₛ is the value of the higher-layer parameter maxNrofCSI-ReportConfigurations.

The value of c may be an index of a serving cell.

The value of s is the value of the higher-layer parameter reportConfigID.

### Example 2

A CSI report may be associated with one priority value, and the priority value is as follows:

$$\\ P = 2 \cdot {N}_{cells} \cdot {M}_{s} \cdot y + {N}_{cells} \cdot {M}_{s} \cdot k + {M}_{s} \cdot c + s$$

For a CSI report carrying L1-RSRP-related information or L1-SINR-related information, k=0; for a CSI report not carrying L1-RSRP-related information or L1-SINR-related information, k=1; and/or for a CSI report carrying Doppler information, k=1; for a CSI report not carrying Doppler information but carrying L1-RSRP-related information or L1-SINR-related information, k=0; for a CSI report not carrying Doppler information but carrying CSI-related information, k=1.

### Example 3

A CSI report may be associated with one priority value, and the priority value is as follows:

$$\\ P = 3 \cdot {N}_{cells} \cdot {M}_{s} \cdot y + {N}_{cells} \cdot {M}_{s} \cdot k + {M}_{s} \cdot c + s$$

For a CSI report carrying L1-RSRP-related information or L1-SINR-related information, k=0; for a CSI report not carrying L1-RSRP-related information or L1-SINR-related information, k=1; and/or for a CSI report carrying Doppler information, k=k1 (0<k1<1, for example, k1=0.5); for a CSI report not carrying Doppler information, k+k1.

### Example 4

A CSI report may be associated with one priority value, and the priority value is as follows:

$$\\ P = 3 \cdot {N}_{cells} \cdot {M}_{s} \cdot y + {N}_{cells} \cdot {M}_{s} \cdot k + {M}_{s} \cdot c + s$$

For a CSI report carrying L1-RSRP-related information or L1-SINR-related information, k=0; for a CSI report not carrying L1-RSRP-related information or L1-SINR-related information, k=1; and/or for a CSI report carrying Doppler information, k=k2 (k2<0, for example, k2=−1); for a CSI report not carrying Doppler information, k+k2.

### Example 5

A CSI report may be associated with one priority value, and the priority value is as follows:

$$\\ P = 3 \cdot {N}_{cells} \cdot {M}_{s} \cdot y + {N}_{cells} \cdot {M}_{s} \cdot k + {M}_{s} \cdot c + s$$

For a CSI report carrying L1-RSRP-related information or L1-SINR-related information, k=0; for a CSI report not carrying L1-RSRP-related information or L1-SINR-related information, k=1; and/or for a CSI report carrying Doppler information, k=2; for a CSI report not carrying Doppler information, k≠2.

The solutions of embodiments of the disclosure are described mainly from the perspective of a method side. It can be understood that, in order to implement the foregoing functions, the terminal or the network device includes a hardware structure and/or a software module for implementing respective functions. Those of ordinary skill in the art will appreciate easily that units and algorithmic operations of various examples described in connection with embodiments herein can be implemented by hardware or by a combination of hardware and computer software. Whether these functions are performed by means of hardware or computer software driving hardware depends on the application and the design constraints of the associated technical solution. Those skilled in the art may use different methods with regard to each particular application to implement the described functionality, but such implementations should not be regarded as lying beyond the scope of the disclosure.

In embodiments of the disclosure, division of functional units of the terminal or the network device may be implemented according to the foregoing method examples. For example, each functional unit may be divided to correspond to each function, or two or more functions may be integrated into one processing unit. The integrated unit may be implemented in the form of hardware, or may be implemented in the form of software program module. It should be noted that, the division of units in embodiments of the disclosure is illustrative, and is only a division of logical functions, and other manners of division may be available in practice.

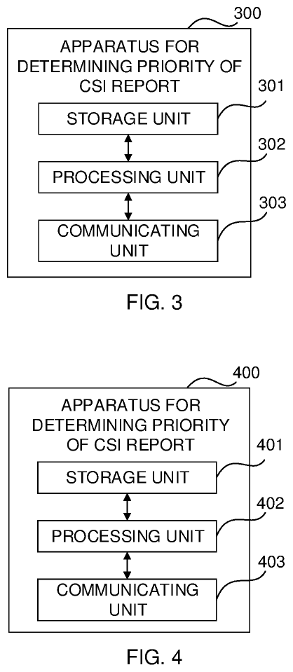

If an integrated unit is adopted, FIG. 3 is a block diagram illustrating functional units of an apparatus for determining a priority of a CSI report. The apparatus 300 includes a processing unit 302 and a communicating unit 303. The processing unit 302 is configured to control and manage actions of a terminal. For example, the processing unit 302 is configured to support the terminal to perform steps in FIG. 2, as well as other procedures in the technical solutions described in the disclosure. The communicating unit 303 is configured to support communication between the terminal and other devices in a wireless communication system. The apparatus 300 may further include a storage unit 301. The storage unit 301 is configured to store program codes executed by the apparatus 300 and data to be transmitted.

It should be noted that, the apparatus 300 may be a chip or a chip module.

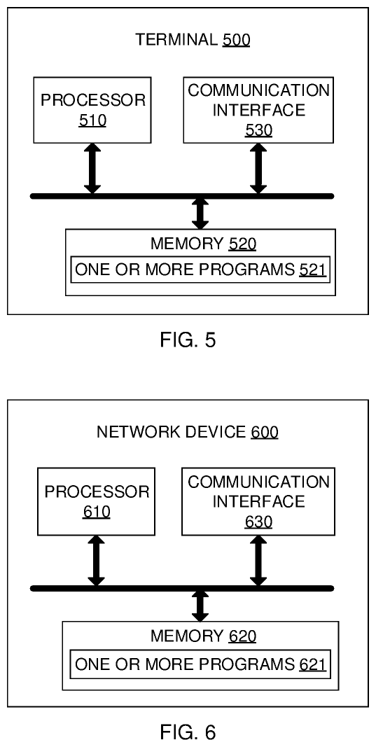

The processing unit 302 may be a processor or a controller, and may be, for example, a central processing unit (CPU), a general-purpose processor, a digital signal processor (DSP), an application-specific integrated circuit (ASIC), a field programmable gate array (FPGA), or other programmable logic devices, transistor logic devices, hardware components, or any combination thereof. Various illustrative logic blocks, modules, and circuits described in connection with the disclosure can be implemented or executed. The processing unit 302 may also be a combination for implementing computing functions, for example, a combination that includes one or more microprocessors, a combination of a DSP and a microprocessor, and the like. The communicating unit 303 may be a communication interface, a transceiver, a transceiver circuit, or the like. The storage unit 301 may be a memory. If the processing unit 302 is a processor, the communicating unit 303 is a communication interface, and the storage unit 301 is a memory, the apparatus 300 in embodiments of the disclosure may be a terminal illustrated in FIG. 5.

During implementation, the processing unit 302 is configured to implement any step performed by the terminal in the foregoing method embodiments. When implementing data transmission such as sending, the processing unit 302 may optionally invoke the communicating unit 303 to complete a corresponding operation. Detailed elaboration will be given below.

The processing unit 302 is configured to obtain configuration information via the communicating unit, and determine, according to the configuration information, a priority of a CSI report at least carrying Doppler information.

It should be noted that, for the implementation of each operation in embodiments illustrated in FIG. 3, reference can be made to the elaboration in method embodiments illustrated in FIG. 2, which will not be described in detail again herein.

As can be seen, the apparatus 300 obtains the configuration information, and determines the priority of the CSI report at least carrying the Doppler information according to the configuration information. As such, the priority of the CSI report at least carrying the Doppler information can be determined according to the configuration information, thereby ensuring robustness and stability of system communication.

Specifically, the Doppler information includes at least one of: at least one Doppler shift, at least one Doppler spread, at least one Doppler shift difference, or at least one Doppler spread difference.

Specifically, the Doppler information is determined according to at least one of: a CSI-RS, a TRS, a DMRS, a data channel, or a control channel.

Specifically, the configuration information includes at least one of: a first configuration parameter, a second configuration parameter, a third configuration parameter, a fourth configuration parameter, a fifth configuration parameter, a sixth configuration parameter, or a seventh configuration parameter. A value of the first configuration parameter is determined according to a maximum number of serving cells. A value of the second configuration parameter is determined according to a maximum number of CSI report configurations. A value of the third configuration parameter is determined according to a report type of the CSI report. A value of the fourth configuration parameter is determined according to an information type to be carried in the CSI report. A value of the fifth configuration parameter is determined according to an index of a serving cell. A value of the sixth configuration parameter is determined according to a configuration ID for the CSI report. A value of the seventh configuration parameter is determined according to a value range of the fourth configuration parameter.

Specifically, the report type of the CSI report includes at least one of: an aperiodic CSI report to be carried on a PUSCH, a semi-persistent CSI report to be carried on a PUSCH, a semi-persistent CSI report to be carried on a PUCCH, or a periodic CSI report to be carried on a PUCCH.

Specifically, the information type to be carried in the CSI report includes at least one of: the Doppler information, L1-RSRP-related information, L1-SINR-related information, or CSI-related information.

Specifically, for the CSI report carrying the Doppler information, the value range of the fourth configuration parameter is [−1, 2].

Specifically, in terms of determining, according to configuration information, the priority of the CSI report at least carrying the Doppler information, the processing unit 302 is specifically configured to: determine the priority of the CSI report at least carrying the Doppler information by using the configuration information according a preset formula, where the preset formula satisfies:

$$\\ P = m \cdot {N}_{cells} \cdot {M}_{s} \cdot y + {N}_{cells} \cdot {M}_{s} \cdot k + {M}_{s} \cdot c + s$$

P represents a value of the priority of the CSI report, N_{cells} represent the first configuration parameter, Mₛ represents the second configuration parameter, y represents the third configuration parameter, k represents the fourth configuration parameter, c represents the fifth configuration parameter, s represents the sixth configuration parameter, and m represents the seventh configuration parameter.

If an integrated unit is adopted, FIG. 4 is a block diagram illustrating functional units of another apparatus for determining a priority of a CSI report. The apparatus 400 for includes a processing unit 402 and a communicating unit 403. The processing unit 402 is configured to control and manage actions of a network device. For example, the processing unit 402 is configured to support the network device to perform steps in FIG. 2, as well as other procedures in the technical solutions described in the disclosure. The communicating unit 403 is configured to support communication between the network device and other devices in a wireless communication system. The apparatus 400 may further include a storage unit 401. The storage unit 401 is configured to store program codes executed by the apparatus 400 and data to be transmitted.

It should be noted that, the apparatus 400 may be a chip or a chip module.

The processing unit 402 may be a processor or a controller, and may be, for example, a CPU, a DSP, an ASIC, a FPGA, or other programmable logic devices, transistor logic devices, hardware components, or any combination thereof. Various illustrative logic blocks, modules, and circuits described in connection with the disclosure can be implemented or executed. The processing unit 402 may also be a combination for implementing computing functions, for example, a combination that includes one or more microprocessors, a combination of a DSP and a microprocessor, and the like. The communicating unit 403 may be a communication interface, a transceiver, a transceiver circuit, or the like. The storage unit 401 may be a memory. If the processing unit 402 is a processor, the communicating unit 403 is a communication interface, and the storage unit 401 is a memory, the apparatus 400 in embodiments of the disclosure may be a network device illustrated in FIG. 6.

During implementation, the processing unit 402 is configured to implement any step performed by the network device in the foregoing method embodiments. When implementing data transmission such as sending, the processing unit 402 may optionally invoke the communicating unit 403 to complete a corresponding operation. Detailed elaboration will be given below.

The processing unit 402 is configured to send configuration information, where the configuration information is used for determining a priority of a CSI report at least carrying Doppler information.

It should be noted that, for the implementation of each operation in embodiments illustrated in FIG. 4, reference can be made to the elaboration in method embodiments illustrated in FIG. 2, which will not be elaborated again herein.

As can be seen, the apparatus 400 sends configuration information. Since the configuration information is used for determining the priority of the CSI report at least carrying the Doppler information, it is possible to determine the priority of the CSI report at least the carrying Doppler information according to the configuration information, thereby ensuring robustness and stability of system communication.

Specifically, the Doppler information includes at least one of: at least one Doppler shift, at least one Doppler spread, at least one Doppler shift difference, or at least one Doppler spread difference.

Specifically, the Doppler information is determined according to at least one of: a CSI-RS, a TRS, a DMRS, a data channel, or a control channel.

Specifically, the configuration information includes at least one of: a first configuration parameter, a second configuration parameter, a third configuration parameter, a fourth configuration parameter, a fifth configuration parameter, a sixth configuration parameter, or a seventh configuration parameter. A value of the first configuration parameter is determined according to a maximum number of serving cells. A value of the second configuration parameter is determined according to a maximum number of CSI report configurations. A value of the third configuration parameter is determined according to a report type of the CSI report. A value of the fourth configuration parameter is determined according to an information type to be carried in the CSI report. A value of the fifth configuration parameter is determined according to an index of a serving cell. A value of the sixth configuration parameter is determined according to a configuration ID for the CSI report. A value of the seventh configuration parameter is determined according to a value range of the fourth configuration parameter.

Specifically, the report type of the CSI report includes at least one of: an aperiodic CSI report to be carried on a PUSCH, a semi-persistent CSI report to be carried on a PUSCH, a semi-persistent CSI report to be carried on a PUCCH, or a periodic CSI report to be carried on a PUCCH.

Specifically, the information type to be carried in the CSI report includes at least one of: the Doppler information, L1-RSRP-related information, L1-SINR-related information, or CSI-related information.

Specifically, for the CSI report carrying the Doppler information, the value range of the fourth configuration parameter is [−1, 2].

Referring to FIG. 5, FIG. 5 is a schematic structural diagram of a terminal provided in embodiments of the disclosure. The terminal 500 includes a processor 510, a memory 520, a communication interface 530, and a communication bus configured to couple the processor 510, the memory 520, and the communication interface 530.

The memory 520 includes, but is not limited to, a random access memory (RAM), a read-only memory (ROM), an erasable programmable ROM (EPROM), or a compact disc ROM (CD-ROM), and is configured to store program codes executed by the terminal 500 and data to be transmitted.

The communication interface 530 is configured to receive and transmit data.

The processor 510 may be one or more CPUs. If the processor 510 is one CPU, the CPU may be a single-core CPU or a multi-core CPU.

The processor 510 in the terminal 500 is configured to read one or more programs 521 stored in the memory 520, to perform the following operations: obtaining configuration information, and determining, according to the configuration information, a priority of a CSI report at least carrying Doppler information.

It should be noted that, for the implementation of each operation, reference can be made to the corresponding elaboration in method embodiments illustrated in FIG. 2, and the terminal 500 can be configured to implement the method at a terminal side in the foregoing method embodiments of the disclosure, which will not be described in detail again herein.

As can be seen, by obtaining the configuration information and determining the priority of the CSI report at least carrying the Doppler information according to the configuration information, it is possible to determine the priority of the CSI report at least carrying the Doppler information according to the configuration information, thereby ensuring robustness and stability of system communication.

Referring to FIG. 6, FIG. 6 is a schematic structural diagram of a network device provided in embodiments of the disclosure. The network device 600 includes a processor 610, a memory 620, a communication interface 630, and a communication bus configured to couple the processor 610, the memory 620, and the communication interface 630.

The memory 620 may include, but is not limited to, a RAM, a ROM, an EPROM, or a CD-ROM. The memory 620 is configured to store related instructions and data.

The communication interface 630 is configured to receive and transmit data.

The processor 610 may be one or more CPUs. If the processor 610 is one CPU, the CPU may be a single-core CPU or a multi-core CPU.

The processor 610 in the network device 600 is configured to read one or more programs 621 stored in the memory 620, to perform the following operations: sending configuration information, where the configuration information is used for determining a priority of a CSI report at least carrying Doppler information.

It should be noted that, for the implementation of each operation, reference an be made to corresponding elaboration in method embodiments illustrated in FIG. 2, and the network device 600 can be configured to perform the method at a network-device side in the foregoing method embodiments of the disclosure, which will not be described in detail again herein.

As can be seen, by sending the configuration information, it is possible to determine the priority of the CSI report at least carrying the Doppler information according to the configuration information, thereby ensuring robustness and stability of system communication.

Embodiments of the disclosure further provide a computer-readable storage medium. The computer-readable storage medium is configured to store computer programs for electronic data interchange (EDI). The computer programs are operable with a computer to implement some or all of the steps performed by the terminal or the network device described in the foregoing method embodiments.

Embodiments of the disclosure further provide a computer program product. The computer program product includes computer programs. The computer programs are operable with a computer to implement some or all of the steps performed by the terminal or the management device described in the foregoing method embodiments. The computer program product may be a software installation package.

It should be noted that, for the sake of brevity, various embodiments above are described as a series of action combinations. It will be appreciated by those skilled in the art that the disclosure is not limited by the sequence of actions described. In embodiments of the disclosure, some steps may be performed in other orders or simultaneously. Besides, it will be appreciated by those skilled in the art that the embodiments described in the specification are preferable embodiments, and the actions, steps, and modules involved are not necessarily essential to the embodiments of disclosure.

In the foregoing embodiments of the disclosure, the illustration of each embodiment has its own emphasis. For the part not described in detail in one embodiment, reference can be made to related illustration in other embodiments.

Those skilled in the art should appreciate that, all or some of the functions of the methods, steps, or related modules/units described in embodiments of the disclosure can be implemented by software, hardware, firmware, or any other combination thereof. When implemented by software, all or some of the functions can be implemented in the form of a computer program product, or may be implemented by a processor executing computer program instructions. The computer program product includes one or more computer instructions, where the computer program instructions may be executed by a corresponding software module. The software module may be stored in a RAM, a flash memory, a ROM, an EPROM, an electrically EPROM (EEPROM), a register, a hard disk, a mobile hard disk, a CD-ROM, or any other form of storage medium known in the art. The computer program instructions may be stored in a computer-readable storage medium or transmitted from one computer-readable storage medium to another computer-readable storage medium. For example, the computer program instructions may be transmitted from one website, computer, server, or data center to another website, computer, server, or data center in a wired manner or a wireless manner. The computer-readable storage medium may be any computer accessible usable-medium or a data storage device such as a server, a data center, or the like which integrates one or more usable media. The usable medium can be a magnetic medium (such as a soft disk, a hard disk, or a magnetic tape), an optical medium, or a semiconductor medium (such as a solid state disk (SSD)), etc.

Various modules/units in various apparatuses or products described in the foregoing embodiments may be each a software module/unit, or may be each a hardware module/unit; or some may be each a software module/unit and the rest may be each a hardware module/unit. For example, with regard to various apparatuses or products applied to or integrated into a chip, various modules/units therein can each be implemented by hardware such as circuit. Alternatively, some of the modules/units therein may be implemented in the form of software programs run on a processor integrated in the chip, and the rest (if any) of the modules/units may be implemented by hardware such as circuit. The same applies to various apparatuses or products applied to or integrated into a chip module, or various apparatuses or products applied to or integrated into a terminal.

The objectives, technical solutions, and advantages of embodiments of the disclosure are described in detail in the foregoing implementations. It should be understood that, the foregoing elaborations are merely implementations of the embodiments of the disclosure, and are not intended to limit the protection scope of the embodiments of the disclosure. Any modifications, equivalent replacements, improvements, and the like made based on the technical solutions of the embodiments of the disclosure shall all fall within the protection scope of the embodiments of the disclosure.

1. A method for determining a priority of a channel state information (CSI) report, comprising:
obtaining configuration information; and
determining, according to the configuration information, a priority of a CSI report at least carrying Doppler information.

2. The method of claim 1, wherein the Doppler information comprises at least one of: at least one Doppler shift, at least one Doppler spread, at least one Doppler shift difference, or at least one Doppler spread difference.

3. The method of claim 1, wherein the Doppler information is determined according to at least one of: a CSI reference signal (CSI-RS), a tracking reference signal (TRS), a demodulation reference signal (DMRS), a data channel, or a control channel.

4. The method of claim 1, wherein the configuration information comprises at least one of: a first configuration parameter, a second configuration parameter, a third configuration parameter, a fourth configuration parameter, a fifth configuration parameter, a sixth configuration parameter, or a seventh configuration parameter, wherein
a value of the first configuration parameter is determined according to a maximum number of serving cells;
a value of the second configuration parameter is determined according to a maximum number of CSI report configurations;
a value of the third configuration parameter is determined according to a report type of the CSI report;
a value of the fourth configuration parameter is determined according to an information type to be carried in the CSI report;
a value of the fifth configuration parameter is determined according to an index of a serving cell;
a value of the sixth configuration parameter is determined according to a configuration identity (ID) for the CSI report; and
a value of the seventh configuration parameter is determined according to a value range of the fourth configuration parameter.

5. The method of claim 4, wherein the report type of the CSI report comprises at least one of: an aperiodic CSI report to be carried on a physical uplink shared channel (PUSCH), a semi-persistent CSI report to be carried on a PUSCH, a semi-persistent CSI report to be carried on a physical uplink control channel (PUCCH), or a periodic CSI report to be carried on a PUCCH.

6. The method of claim 4, wherein the information type to be carried in the CSI report comprises at least one of: the Doppler information, layer 1 reference signal received power (L1-RSRP)-related information, L1 signal-to-noise and interference ratio (L1-SINR)-related information, or CSI-related information.

7. The method of claim 4, wherein for the CSI report carrying the Doppler information, the value range of the fourth configuration parameter is [−1, 2].

8. The method of claim 4 wherein determining, according to the configuration information, the priority of the CSI report at least carrying the Doppler information comprises:
determining the priority of the CSI report at least carrying the Doppler information by using the configuration information according a preset formula, wherein the preset formula satisfies:
$$\\ P = m \cdot {N}_{cells} \cdot {M}_{s} \cdot y + {N}_{cells} \cdot {M}_{s} \cdot k + {M}_{s} \cdot c + s$$
wherein P represents a value of the priority of the CSI report, N_{cells} represent the first configuration parameter, Mₛ represents the second configuration parameter, y represents the third configuration parameter, k represents the fourth configuration parameter, c represents the fifth configuration parameter, s represents the sixth configuration parameter, and m represents the seventh configuration parameter.

9-15. (canceled)

16. A terminal, comprising a processor, a memory, a communication interface, and at least one program, wherein the at least one program is stored in the memory and configured to be executed by the processor to:
obtain configuration information via the communication interface; and
determine, according to the configuration information, a priority of a CSI report at least carrying Doppler information.

17. The terminal of claim 16, wherein the Doppler information comprises at least one of: at least one Doppler shift, at least one Doppler spread, at least one Doppler shift difference, or at least one Doppler spread difference.

18. The terminal of claim 16, wherein the Doppler information is determined according to at least one of: a CSI reference signal (CSI-RS), a tracking reference signal (TRS), a demodulation reference signal (DMRS), a data channel, or a control channel.

19. The terminal of claim 16, wherein the configuration information comprises at least one of: a first configuration parameter, a second configuration parameter, a third configuration parameter, a fourth configuration parameter, a fifth configuration parameter, a sixth configuration parameter, or a seventh configuration parameter, wherein
a value of the first configuration parameter is determined according to a maximum number of serving cells;
a value of the second configuration parameter is determined according to a maximum number of CSI report configurations;
a value of the third configuration parameter is determined according to a report type of the CSI report;
a value of the fourth configuration parameter is determined according to an information type to be carried in the CSI report;
a value of the fifth configuration parameter is determined according to an index of a serving cell;
a value of the sixth configuration parameter is determined according to a configuration identity (ID) for the CSI report; and
a value of the seventh configuration parameter is determined according to a value range of the fourth configuration parameter.

20. The terminal of claim 19, wherein the report type of the CSI report comprises at least one of: an aperiodic CSI report to be carried on a physical uplink shared channel (PUSCH), a semi-persistent CSI report to be carried on a PUSCH, a semi-persistent CSI report to be carried on a physical uplink control channel (PUCCH), or a periodic CSI report to be carried on a PUCCH.

21. The terminal of claim 19, wherein the information type to be carried in the CSI report comprises at least one of: the Doppler information, layer 1 reference signal received power (L1-RSRP)-related information, L1 signal-to-noise and interference ratio (L1-SINR)-related information, or CSI-related information.

22. The terminal of claim 19, wherein for the CSI report carrying the Doppler information, the value range of the fourth configuration parameter is [−1, 2].

23. The terminal of claim 19, wherein the processing unit configured to determine, according to the configuration information, the priority of the CSI report at least carrying the Doppler information is configured to:
determine the priority of the CSI report at least carrying the Doppler information by using the configuration information according a preset formula, wherein the preset formula satisfies:
$$\\ P = m \cdot {N}_{cells} \cdot {M}_{s} \cdot y + {N}_{cells} \cdot {M}_{s} \cdot k + {M}_{s} \cdot c + s$$
wherein P represents a value of the priority of the CSI report, N_{cells} represent the first configuration parameter, Mₛ represents the second configuration parameter, y represents the third configuration parameter, k represents the fourth configuration parameter, c represents the fifth configuration parameter, s represents the sixth configuration parameter, and m represents the seventh configuration parameter.

24-32. (canceled)

33. A non-transitory computer-readable storage medium configured to store computer programs and data for electronic data interchange (EDI) wherein the computer programs and data are operable with a computer to:
obtain configuration information; and
determine, according to the configuration information, a priority of a CSI report at least carrying Doppler information.

34. (canceled)

35. The non-transitory computer-readable storage medium of claim 33, wherein the Doppler information comprises at least one of: at least one Doppler shift, at least one Doppler spread, at least one Doppler shift difference, or at least one Doppler spread difference.

36. The non-transitory computer-readable storage medium of claim 33, wherein the Doppler information is determined according to at least one of: a CSI reference signal (CSI-RS), a tracking reference signal (TRS), a demodulation reference signal (DMRS), a data channel, or a control channel.

37. The non-transitory computer-readable storage medium of claim 33, wherein the configuration information comprises at least one of: a first configuration parameter, a second configuration parameter, a third configuration parameter, a fourth configuration parameter, a fifth configuration parameter, a sixth configuration parameter, or a seventh configuration parameter, wherein
a value of the first configuration parameter is determined according to a maximum number of serving cells;
a value of the second configuration parameter is determined according to a maximum number of CSI report configurations;
a value of the third configuration parameter is determined according to a report type of the CSI report;
a value of the fourth configuration parameter is determined according to an information type to be carried in the CSI report;
a value of the fifth configuration parameter is determined according to an index of a serving cell;
a value of the sixth configuration parameter is determined according to a configuration identity (ID) for the CSI report; and
a value of the seventh configuration parameter is determined according to a value range of the fourth configuration parameter.
